(19) United States
(12) Patent Application Publication
(10) Pub. No.: US 2012/0305743 A1
(43) Pub. Date: Dec. 6, 2012

(54) FAN BRACKET ASSEMBLY

(76) Inventors: Jack R. Kerr, JR., Hearne, TX (US); Fran Hurley, Philadephia, PA (US)

(21) Appl. No.: 13/460,756

(22) Filed: Apr. 30, 2012

Related U.S. Application Data
(60) Provisional application No. 61/481,181, filed on Apr. 30, 2011.

(51) Int. Cl. F16M 9/00; F16M 13/02

(52) U.S. Cl. 248/666; 248/674

(57) ABSTRACT

A fan bracket assembly for supporting a fan assembly from a slanted surface. The fan bracket assembly includes a main body having a peripheral section, an open area sized to hold wiring of the fan assembly and an extension. The fan bracket is affixed to a slanted surface. The fan bracket assembly includes a detachable mounting ball sized and shaped to fit and be retained within the peripheral section. The mounting ball has a surface area extending beyond a horizontal reference line bisecting the mounting ball and a slot extending beyond the horizontal reference line. The extension is positioned within the slot to rotationally restrain the mounting ball. The bracket assembly also includes a down rod attached to the mounting ball for supporting the fan assembly. When the fan assembly is hung from the down rod, the extension remains within the slot to rotationally restrain the mounting ball.

### RELATED APPLICATIONS

This utility application claims the benefit of U.S. Provisional Patent Application Ser. No. 61/481,181 filed Apr. 30, 2011 by Jack R. Kerr and Fran Hurley, Jr., which is hereby incorporated by reference.

### BACKGROUND OF THE INVENTION

1. Field of the Invention

This invention relates to support assemblies. Specifically, and not by way of limitation, the present invention relates to a fan bracket assembly affixed to a slanted surface for supporting a fan.

2. Description of the Related Art

In many homes, ceiling fans are quite popular. The fans include a fan assembly which is typically mounted to a ceiling in a room. These fan assemblies are normally attached to one or more structural supports, such as joists or studs. However, there are several problems associated with mounting a fan assembly to a slanted surface, such as a slanted wall or canted ceiling. Specifically, existing fan bracket assemblies do not sufficiently support a fan assembly beyond an angle between a down rod of the fan assembly and the bracket of approximately 30 degrees. When the ceiling fan is mounted onto a slanted surface which is angled beyond approximately 30 degrees, a mounting ball which enables the down rod and fan to hang from the bracket assembly extends beyond a restraining device in the bracket.

FIG. 1 is a front view illustrating an existing fan bracket assembly 10. A down rod 12 includes a mounting ball 14 attached to the bracket assembly 10. The bracket assembly includes an open area 16 for storage of electrical connections of a fan (not shown). FIG. 2 is a side view illustrating the existing fan bracket assembly 10 at an angle limit θ between the down rod 12 and a line parallel to the bracket assembly. As illustrated, an upper portion 20 of the mounting ball includes a slot 22 which engages an extension 24 affixed to a bottom of the bracket assembly. Normally, the extension 24 is positioned within the slot 22 and guides the mounting ball and attached down rod to prevent swiveling of the fan and down rod. When the bracket assembly is attached to a slanted surface, due to gravity, the down rod rotates toward the ground. When the down rod is angled beyond an angle limit (limited by the length of the slot), the extension is positioned outside of the slot. By positioning the extension outside the slot, the fan and down rod rotates freely. Furthermore, wires located above the mounting ball in the open area 16 are exposed through the exposed area above the ball (where pencil is pointing in FIG. 2).

FIG. 3 is a top view of the bracket assembly 10 separated from the mounting ball 14. The fan bracket assembly includes one or more wing segments 28 for attachment to a surface. The mounting ball also includes a top end 30. This top end 30 is flat without any slant.

Furthermore, it is becoming far more common to utilize wireless remote control mechanisms to control a fan attached to the bracket assembly. However, existing bracket assemblies do not provide sufficient room for storing both the remote control mechanism and wiring attached fan. In addition, the open areas of the bracket assembly do not have any mechanism to secure the remote control mechanism in the open areas.

Therefore, it would be advantageous to have a fan bracket assembly which may be mounted to slanted surfaces and retain remote control devices in open areas of the bracket assembly. It is an object of the present invention to provide such an apparatus.

### SUMMARY OF THE INVENTION

In one aspect, the present invention is a fan bracket assembly for supporting a fan assembly from a slanted surface. The fan bracket assembly includes a main body having a peripheral section, an open area sized to hold wiring of the fan assembly and an extension. The fan bracket is affixed to a slanted surface. The fan bracket assembly includes a detachable mounting ball sized and shaped to fit and be retained within the peripheral section. The mounting ball has a surface area extending beyond a horizontal reference line bisecting the mounting ball. A slot is positioned on the surface area extending beyond the horizontal reference line. The extension is positioned within the slot to rotationally restrain the mounting ball. The bracket assembly also includes a down rod attached to the mounting ball for supporting the fan assembly. When the fan assembly is hung from the down rod, the extension remains within the slot to rotationally restrain the mounting ball.

In another embodiment, the main body includes a plurality of retainer arms for retaining a remote control mechanism in the open area. In still another embodiment, the down rod includes a collar. The collar is capable of affixing the down rod having a first diameter to a mounting ball sized to fit a second diameter larger than the first diameter.

In still another embodiment, the present invention is an adapter plate for moving an axial orientation of a fan bracket assembly affixed to a surface. The adapter plate includes a planar surface with a plurality of slots, a retention mechanism for retaining the fan bracket assembly to the adapter plate, and a retention mechanism for retaining the adapter plate to a surface. The planar surface may be rotated to change the axial orientation of the fan bracket assembly in relationship to surface to which the fan bracket assembly is affixed

### BRIEF DESCRIPTION OF THE DRAWINGS

FIG. 1 (prior art) is a front view illustrating an existing fan bracket assembly;

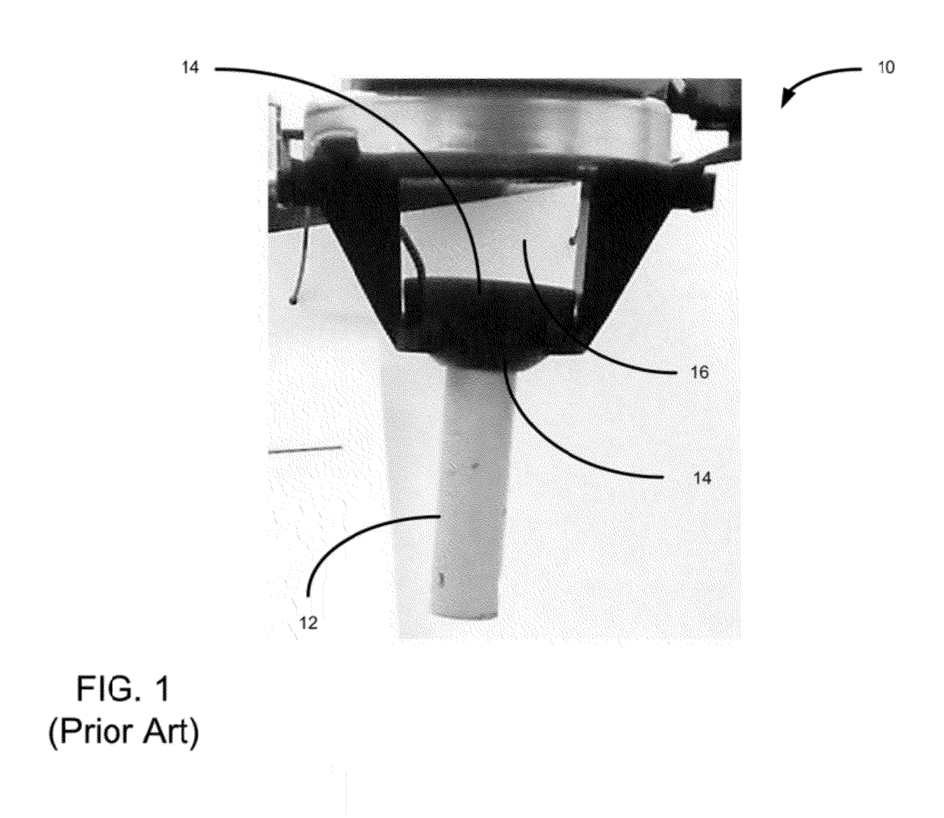

FIG. 2 (prior art) is a side view illustrating the existing fan bracket assembly of FIG. 1 at an angle limit θ;

FIG. 3 (prior art) is a top view of the bracket assembly of FIG. 1 separated from the mounting ball 14;

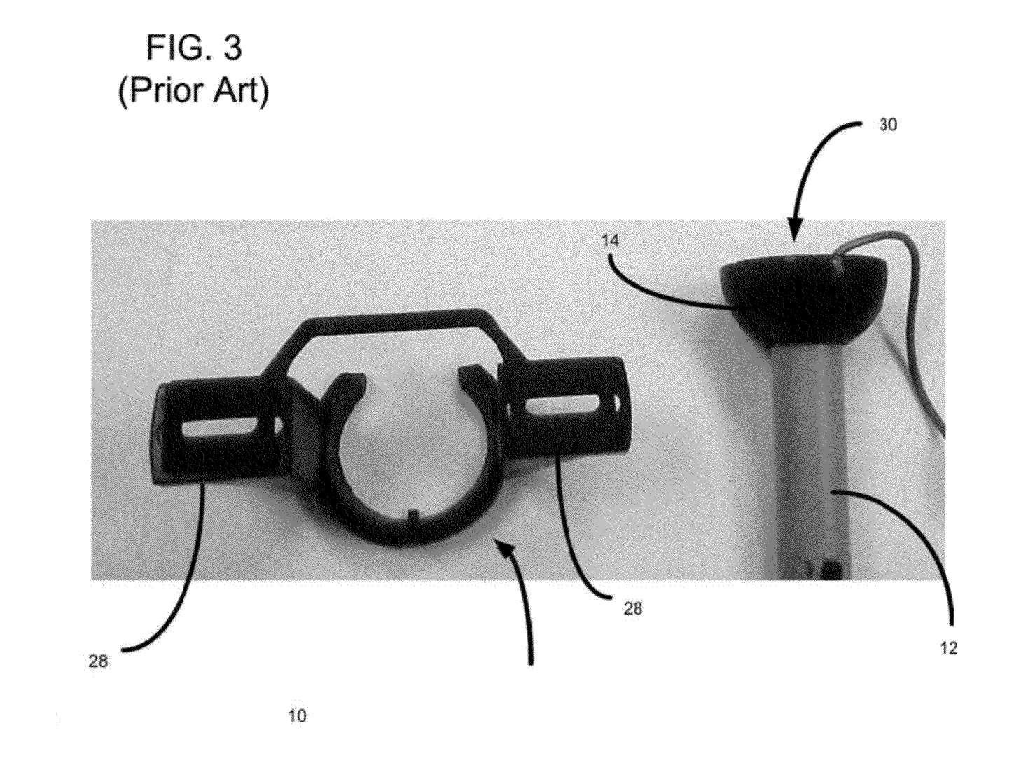

FIG. 4 is a top view of a fan bracket assembly separated from a mounting ball and down rod in one embodiment of the present invention;

FIG. 5 is a side view of the mounting ball and down rod;

FIG. 6 is a side view illustrating the fan bracket assembly of FIG. 4 hanging from a surface;

FIG. 7 is a front view illustrating the fan bracket assembly of FIG. 4;

FIG. 8 is an enlarged front view illustrating the slot and the extension positioned in the slot;

FIG. 9 is a side by side view of the mounting ball of the present invention and the existing mounting ball;

FIG. 10 is a side view illustrating the fan bracket assembly of FIG. 4;

FIG. 11 is a side view illustrating a remote control mechanism located within the open area;

FIG. 12 is a top view illustrating the down rod fitted with a collar;

FIG. 13 (prior art) is a bottom view illustrating an existing standard electrical box;

FIG. 14 is side view illustrating the fan bracket assembly of FIG. 4 affixed to the box;

FIG. 15 is a side view illustrating the mounting ball and down rod within the fan bracket assembly affixed to the standard box;

FIG. 16 is a bottom view illustrating an adapter plate mounted to the standard box of FIG. 13 in another embodiment of the present invention;

FIG. 17 is a side view illustrating the mounting ball and down rod positioned in the fan bracket assembly of FIG. 4 attached to the adapter plate and standard box;

FIG. 18 is a bottom view illustrating an adapter plate in an alternate embodiment of the adapter plate 450 of FIG. 16;

FIG. 19 is a bottom view illustrating the adapter plate of FIG. 18 holding a remote control mechanism; and

FIG. 20 is a side view of the mounting ball.

### DESCRIPTION OF THE INVENTION

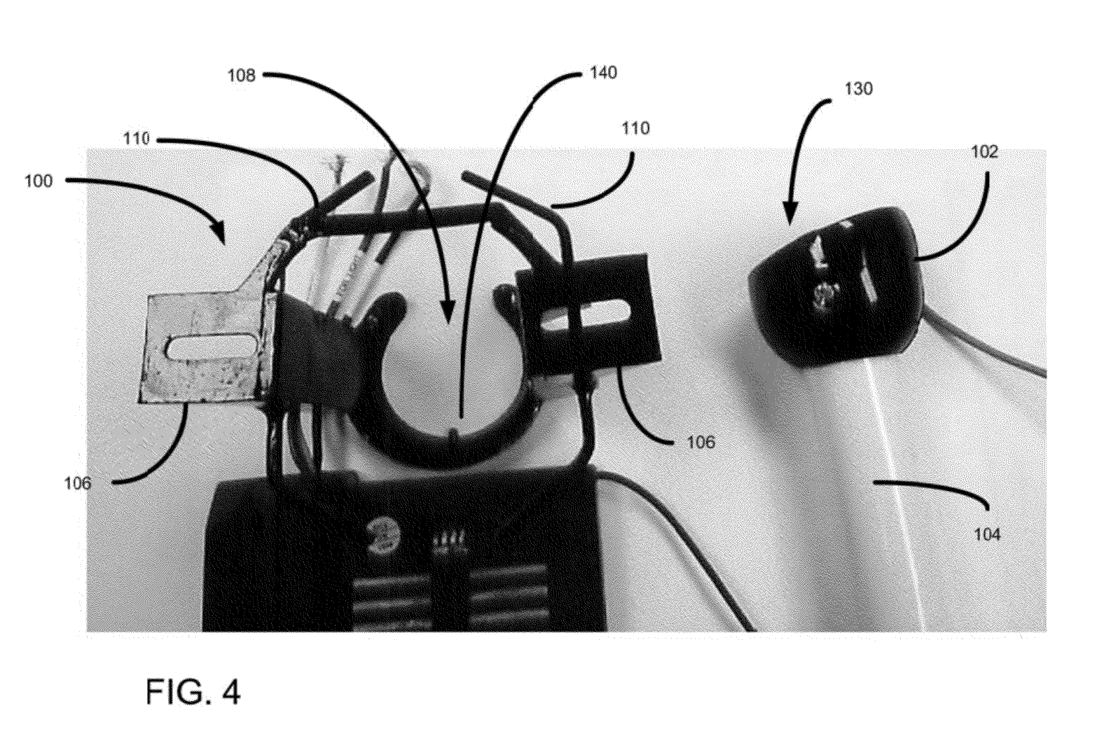

The present invention is a fan bracket assembly for use on a slanted surface. FIG. 4 is a top view of a fan bracket assembly 100 separated from a mounting ball 102 and down rod 104 in one embodiment of the present invention. The fan bracket assembly 100 includes wing segments 106, an open area 108, and retaining bars 110. The mounting ball includes a slanted top end 130 and a slot 132.

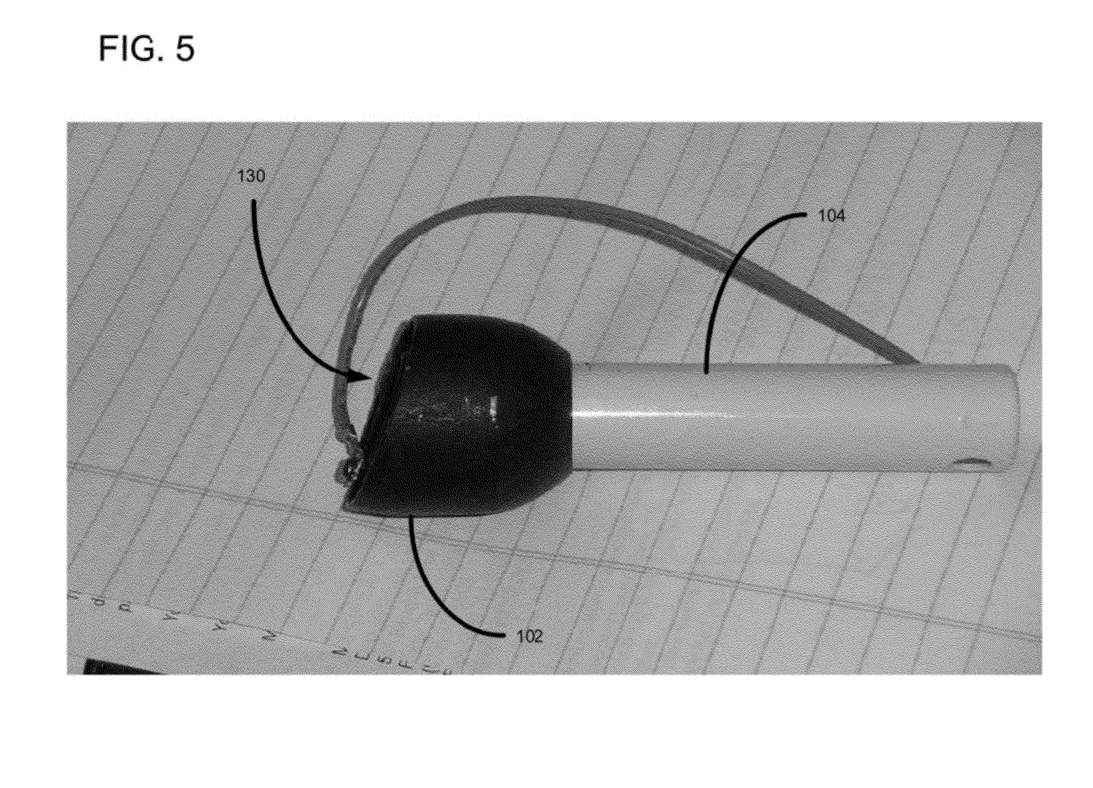

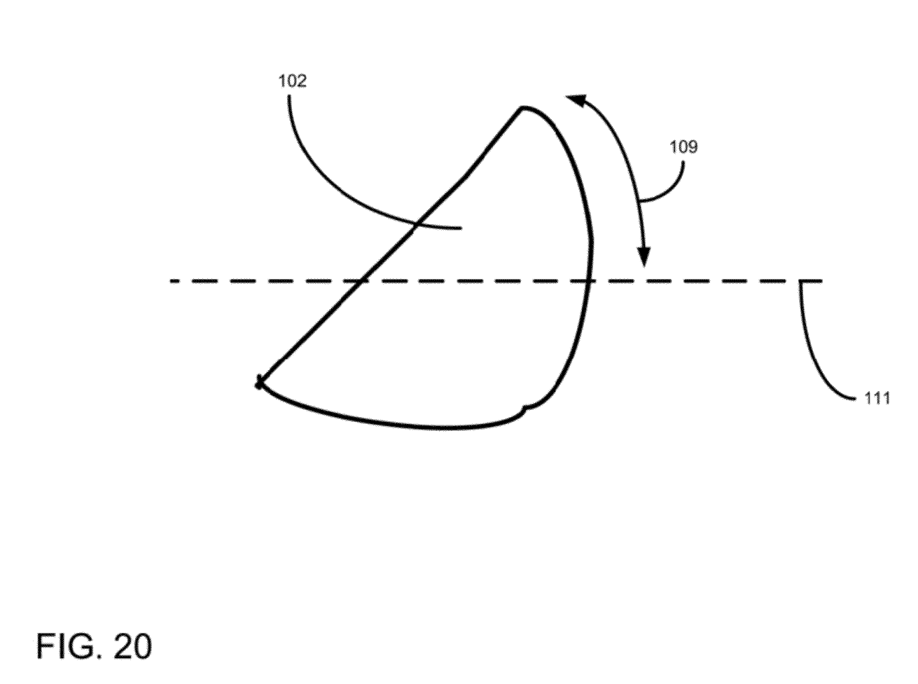

FIG. 5 is a side view of the mounting ball 102 and down rod 104. Unlike the flat top end 30 of the mounting ball 14, the present invention includes the slanted top end 130. By slanting the top end 130, the mounting ball has a larger surface area allowing the slot 132 to extend upward beyond a flat top end 30 of the existing mounting ball (see FIG. 20). Thus, the slot 132 may retain the extension 140 (see FIG. 4) of the fan bracket assembly 100 to a greater angle.

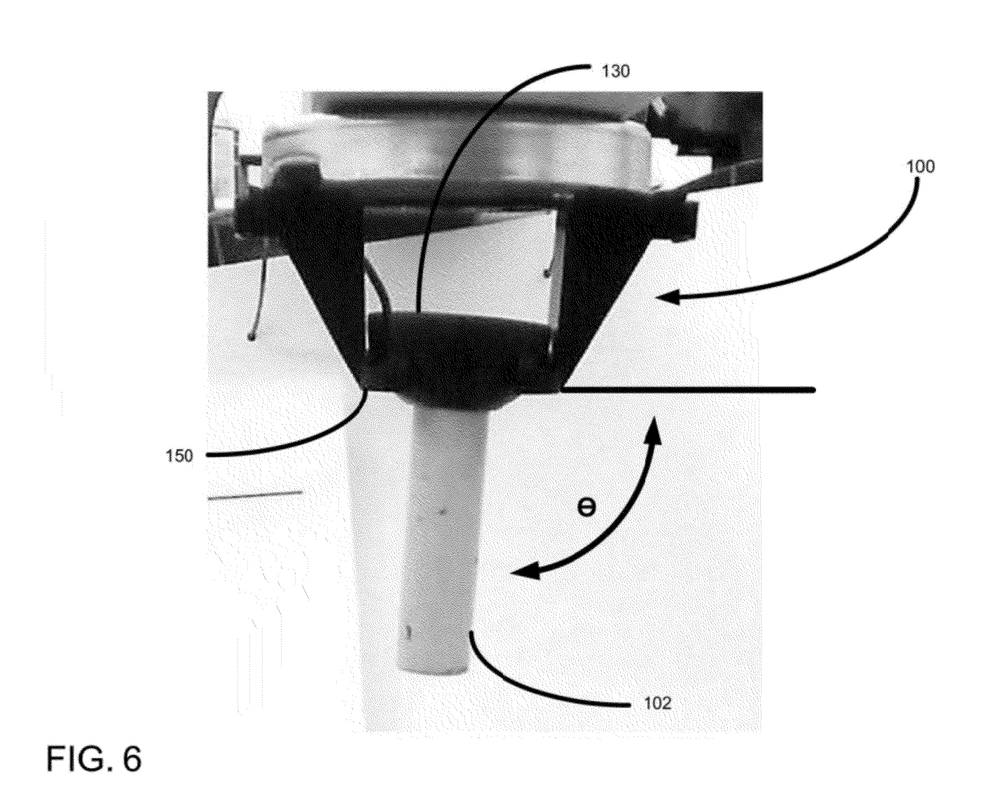

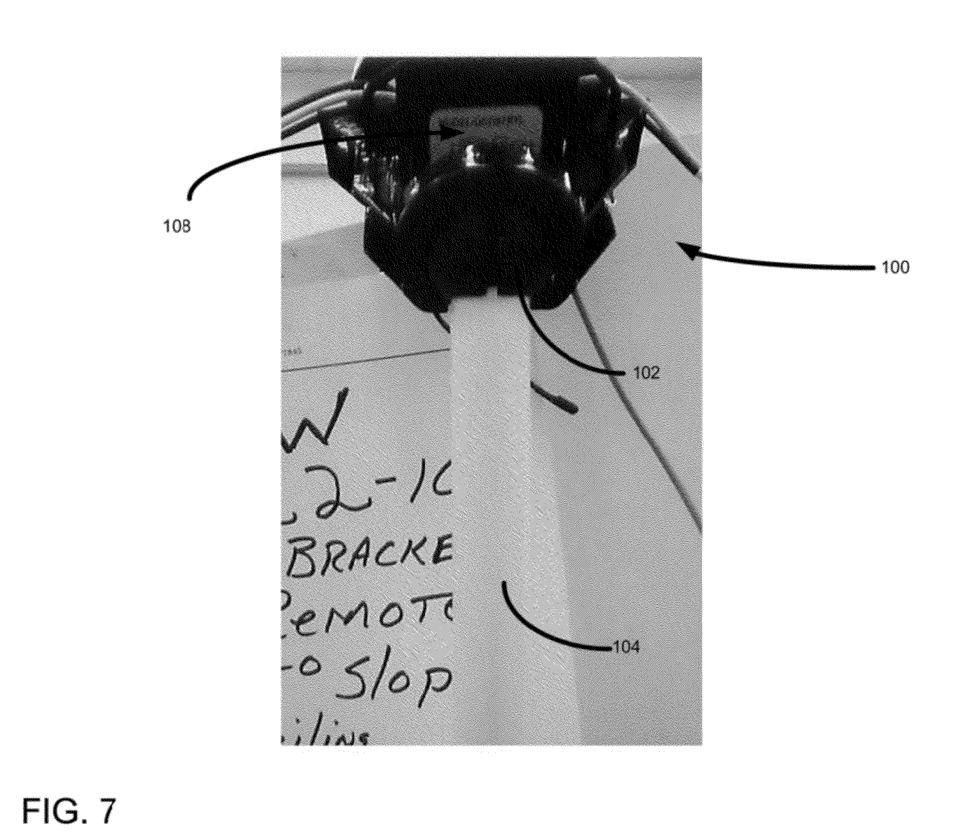

FIG. 6 is a side view illustrating the fan bracket assembly 100 hanging from a surface. The down rod 104 rotates toward the ground due to gravity. The extension 140 is retained in the slot, thereby preventing swiveling of the fan or down rod. Furthermore, due to the shape of the mounting ball, the mounting ball does not have any areas where wires within the bracket assembly may be exposed. FIG. 7 is a front view illustrating the fan bracket assembly 100. The open area 108 may optionally be enlarged to accommodate a remote control mechanism and wiring for a fan.

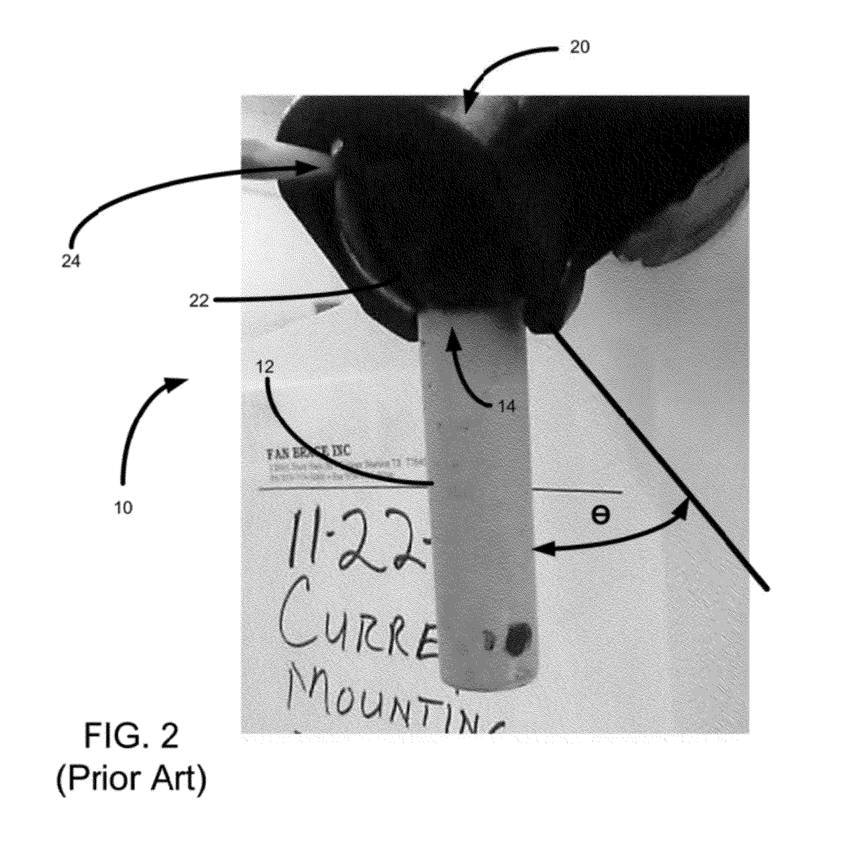

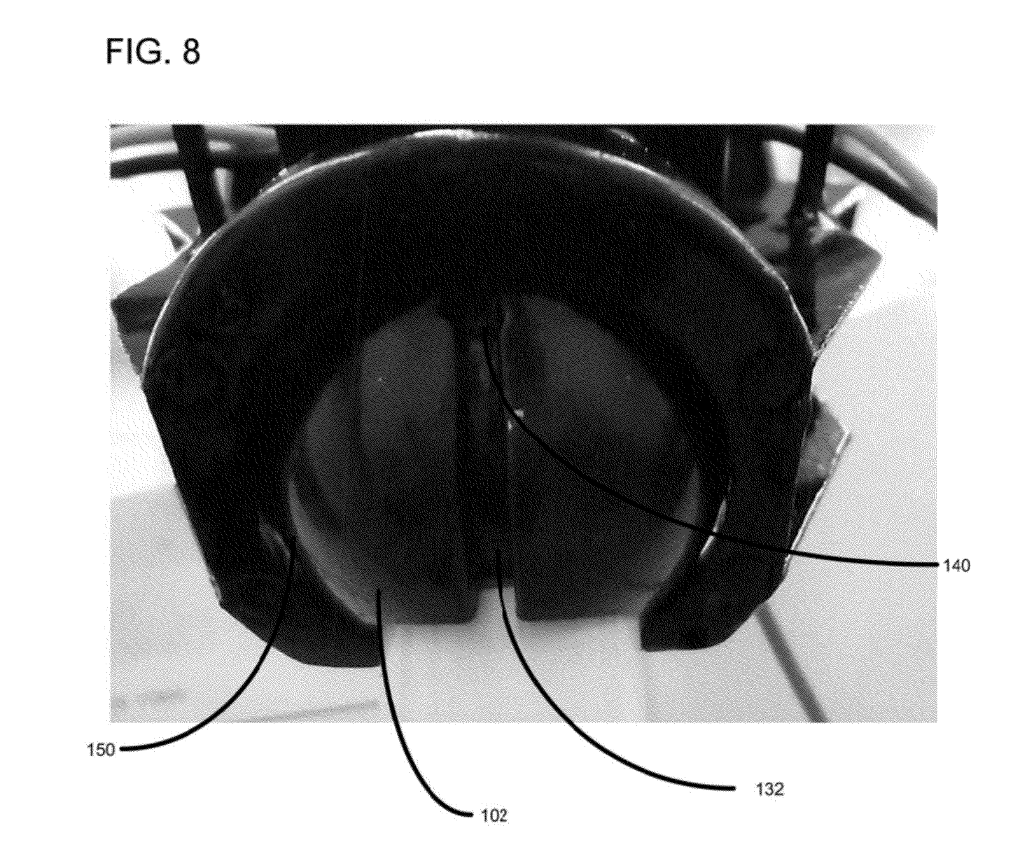

FIG. 8 is an enlarged front view illustrating the slot 132 and the extension 140 positioned in the slot. Upon a slanted surface, the angle α (see FIG. 6) between the down rod and parallel to a peripheral section 150 of the bracket assembly 100 may go beyond the angle limit θ of the bracket assembly 10 of FIG. 2 and still allow the extension 140 to remain in the slot 132. The mounting ball is sized and shaped to fit within the peripheral section 150 and allow movement while securely holding a load hanging from the down rod 104.

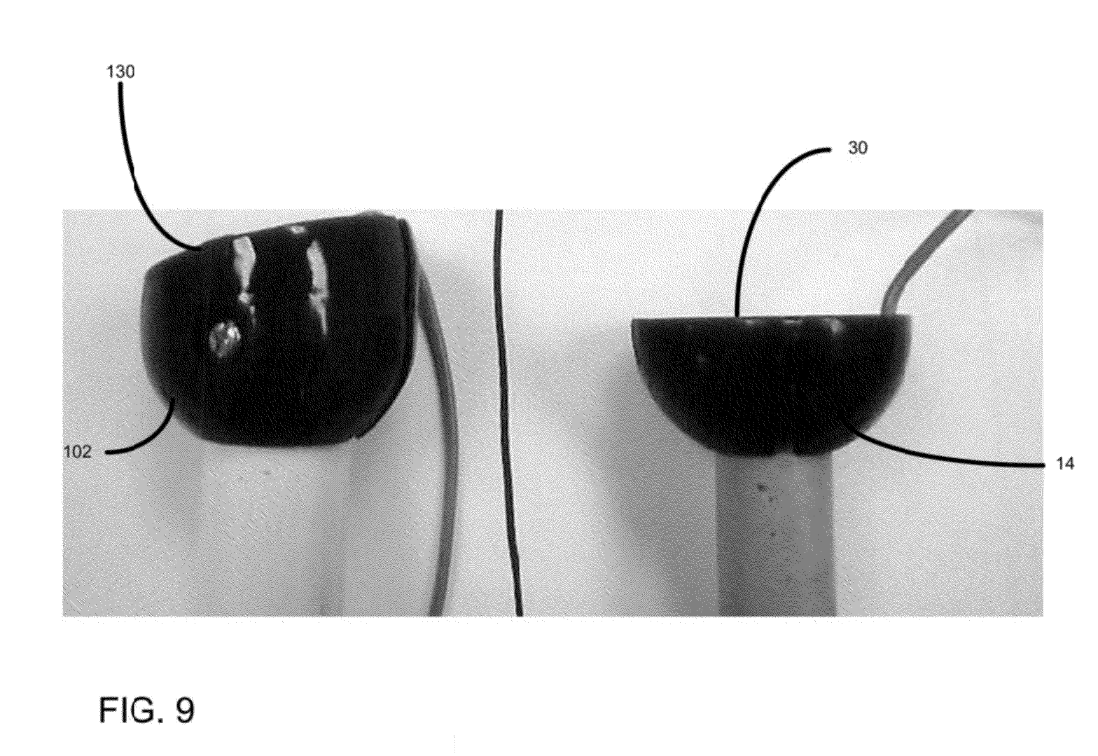

FIG. 9 is a side by side view of the mounting ball 102 of the present invention and the existing mounting ball 14. The mounting ball 102 includes the slanted top end 130. The mounting ball 14 includes the top end 130 which is flat (i.e., no slant). The slanted top end 130 provides a larger surface area, thereby allowing the slot to extend upward beyond a horizontal reference line bisecting the mounting ball and enables the mounting ball to be moved to a positioned past the angular limits of the mounting ball 14 of the existing bracket assembly 10.

FIG. 20 is a side view of the mounting ball 102. The mounting ball includes a surface area 109 extending beyond a horizontal reference line 111 notionally running horizontal though the mounting ball. The slot 132 may likewise extend upward beyond the horizontal reference line, thereby allowing the mounting ball and connected down rod beyond the angular limits of the mounting ball 14 (which does not have its slot extending beyond the horizontal reference line). It should be understood that the extended surface area may extend any length beyond the horizontal line and still remain in the scope of the present invention. For example, the mounting ball may be any shape which extends the surface area of the mounting ball beyond the horizontal reference line, such as a complete sphere, a half sphere (shown in FIG. 20), a three quarters sphere, etc.

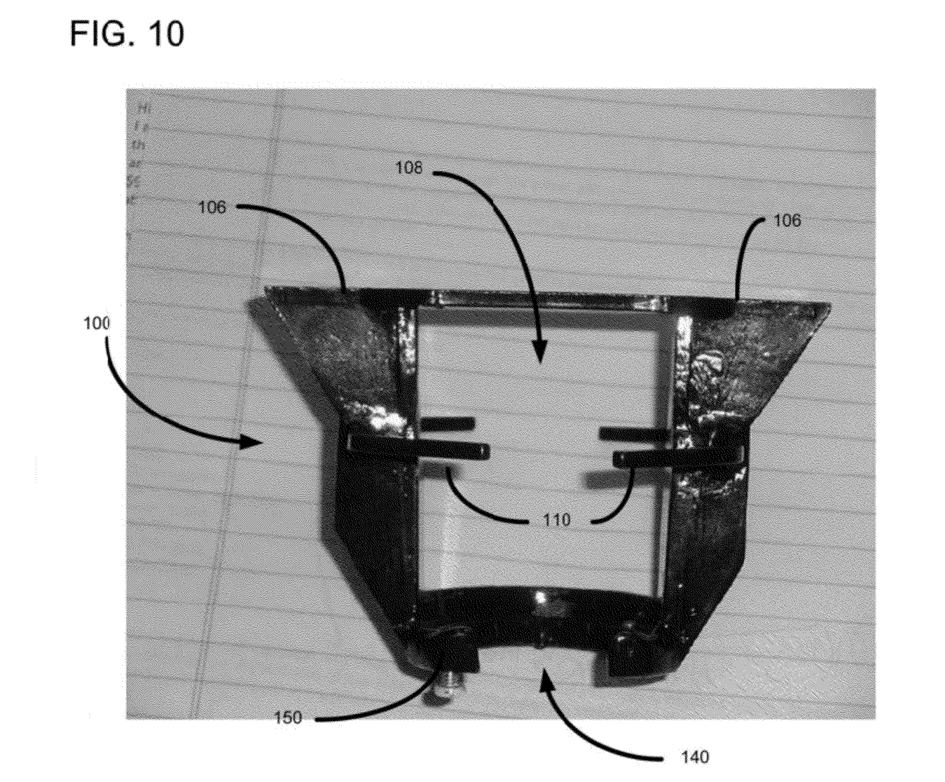

FIG. 10 is a side view illustrating the fan bracket assembly 100. The fan bracket assembly includes the open area 108 which may be sized to fit a remote control mechanism and wiring for a fan loaded on the bracket assembly 100. The bracket includes retaining bars 110 to hold a remote control mechanism within the open area 108.

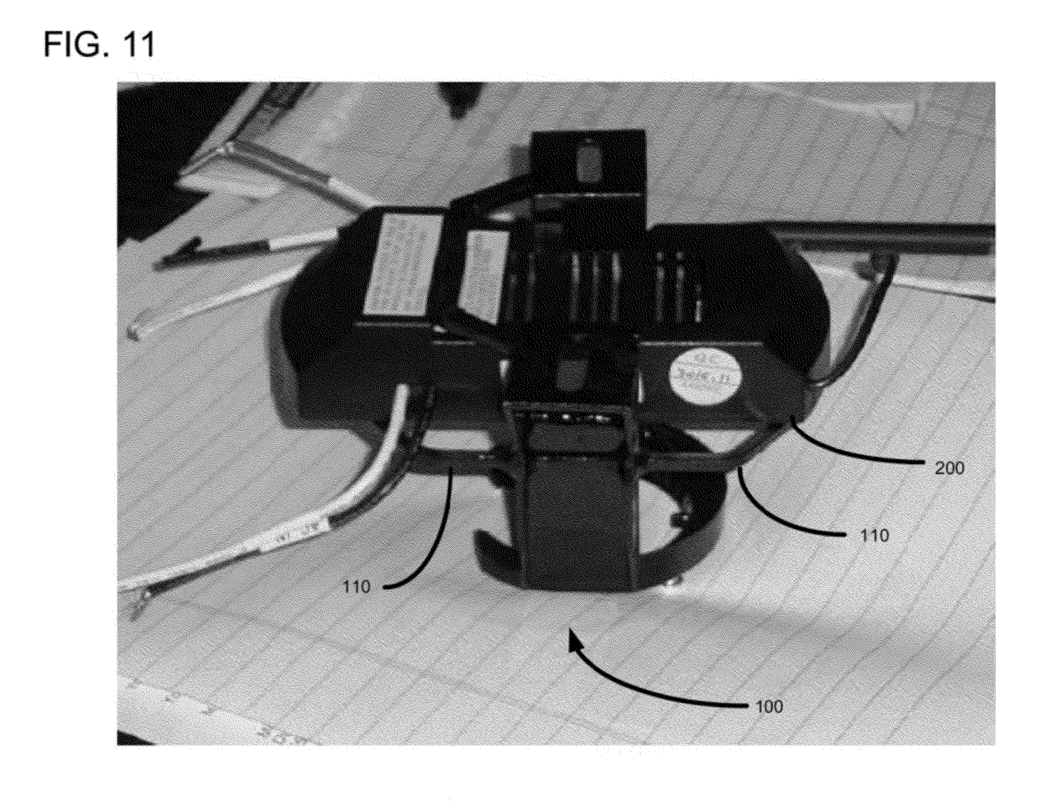

FIG. 11 is a side view illustrating a remote control mechanism 200 located within the open area 108. The remote control mechanism may be retained in the open area 108 by the plurality of retaining bars 110. The enlarged open area enables the remote control mechanism to be held in place in the open area 108 while providing sufficient space for retaining any wiring from a fan unit. Although retaining bars 110 are shown, any retaining mechanisms may be used and still remain in the scope of the present invention.

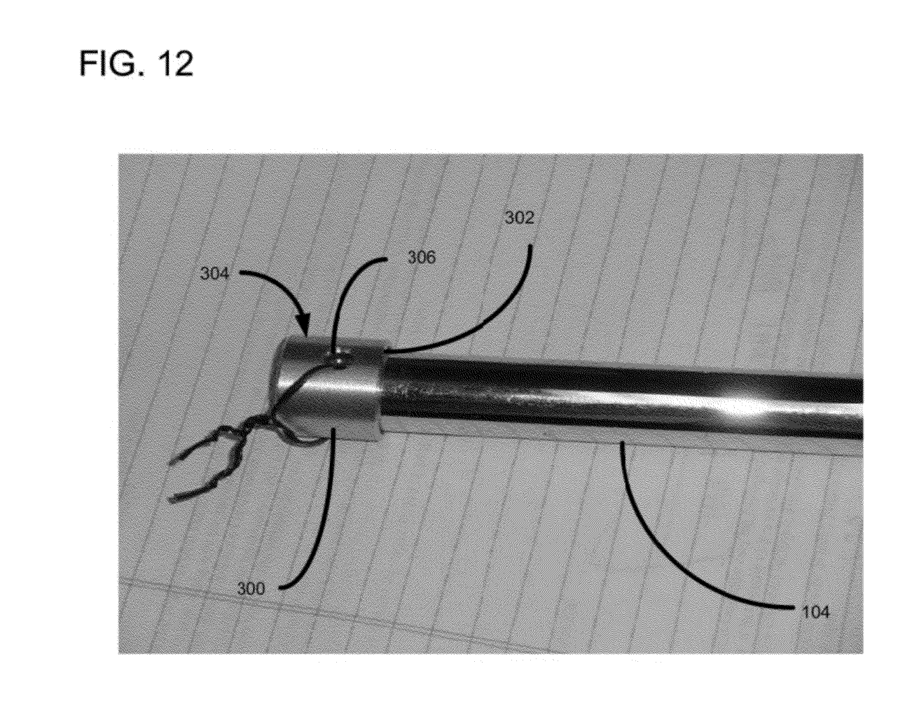

FIG. 12 is a top view illustrating the down rod 104 fitted with a collar 300. Many down rods have ½ inch or ¾ inch diameters. For down rods having a diameter of ½ inch, the down rods are normally unable to be used with brackets used for ¾ inch down rods. The present invention includes a collar 300 which enables the smaller diameter down rods to be used in bracket assemblies sized for larger diameter down rods. The collar includes a bore 302 for accommodating the down rod, such as a ½ inch diameter. The collar 300 includes an outer surface 304 increasing the diameter to ¾ of an inch. The collar may include one or more holes aligned with one or more holes 306 located on the down rod. A screw, bolt or other mechanism may be used to retain the collar against the down rod. By using the collar 300, the ½ inch down rod may be used in bracket assemblies accommodating ¾ inch down rods. Although ½ inch and ¾ inch down rods are discussed, the collar 300 may be sized to accommodate any diameter of a down rod while increasing the down rod diameter to a greater diameter.

The present invention enables a fan assembly to be mounted to a slanted surface and still enable the mounting ball's slot to be restrained by the extension 140. In addition, the fan bracket assembly provides sufficient space to accommodate a remote control mechanism as well as wiring for a fan. In addition, the present invention may include a collar for use on a down rod to allow a smaller diameter down rod to be used for a bracket assembly sized for a larger diameter mounting ball. In addition, in one embodiment, the fan bracket with an open space for retaining a remote control mechanism may be utilized with any fan fixture assemblies and mounting ball and is not limited to the slanted mounted ball configuration.

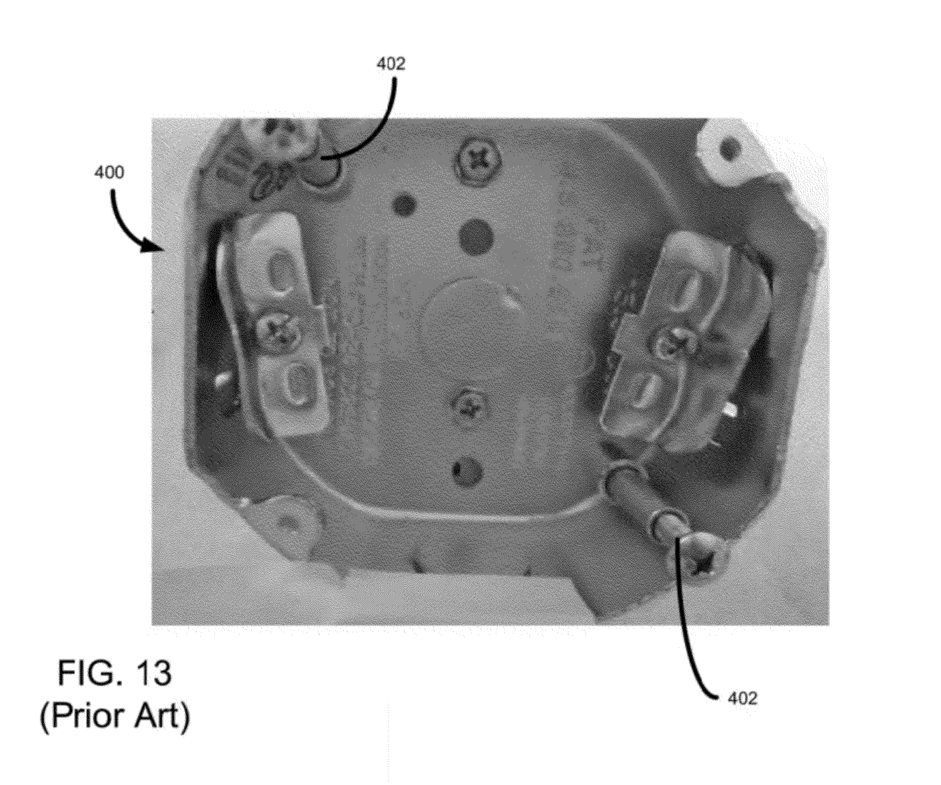

FIG. 13 is a bottom view illustrating an existing standard electrical box 400 which is typically affixed to a support member such as a joist (not shown). The standard box 400 typically houses wires running from a light or fan fixture to electrical wiring in the building or home. FIG. 13 illustrates mounting screws 402 for which a fan bracket assembly is typically attached.

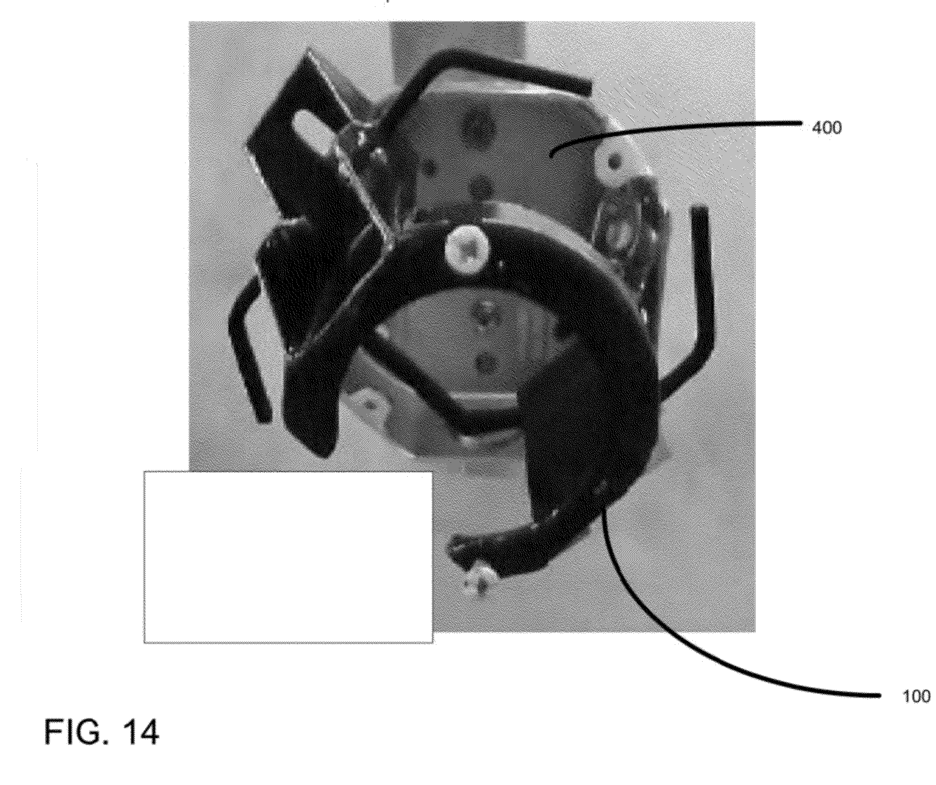

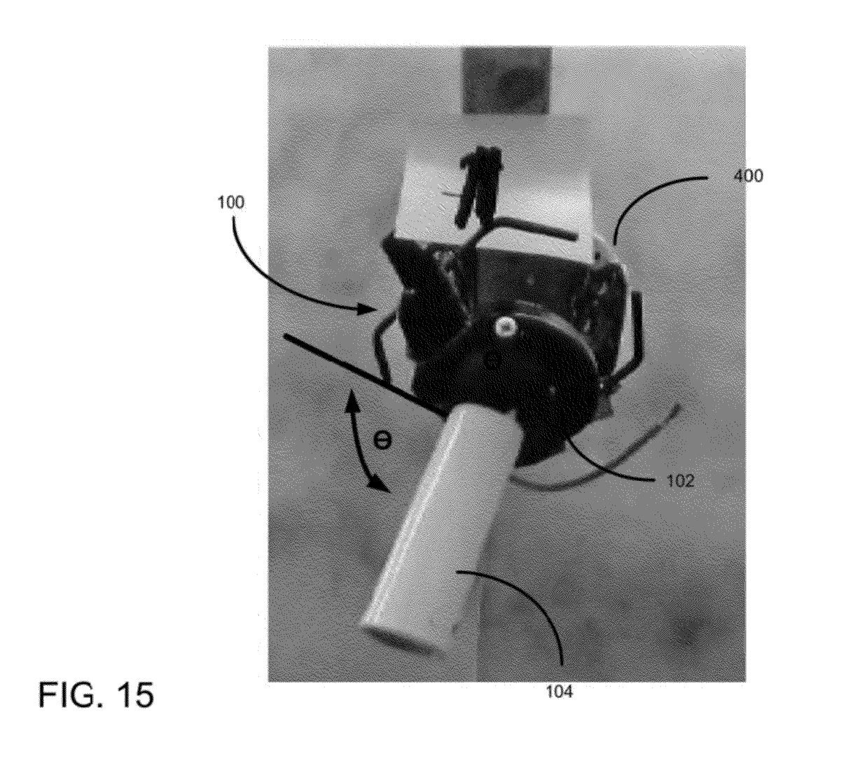

FIG. 14 is side view illustrating the fan bracket assembly 100 affixed to the box 400. FIG. 15 is a side view illustrating the mounting ball 102 and down rod 104 within the fan bracket assembly 100 affixed to the standard box 400. Even with the modifications to the mounting ball 102 having the slanted top end 130, the down rod 104 is unable to extend directly perpendicular to the ground. Specifically, because of the orientation of the mounting screws 402 where the fan bracket assembly 100 is affixed, the fan bracket assembly is mounted at an orientation that the down rod cannot extend straight down.

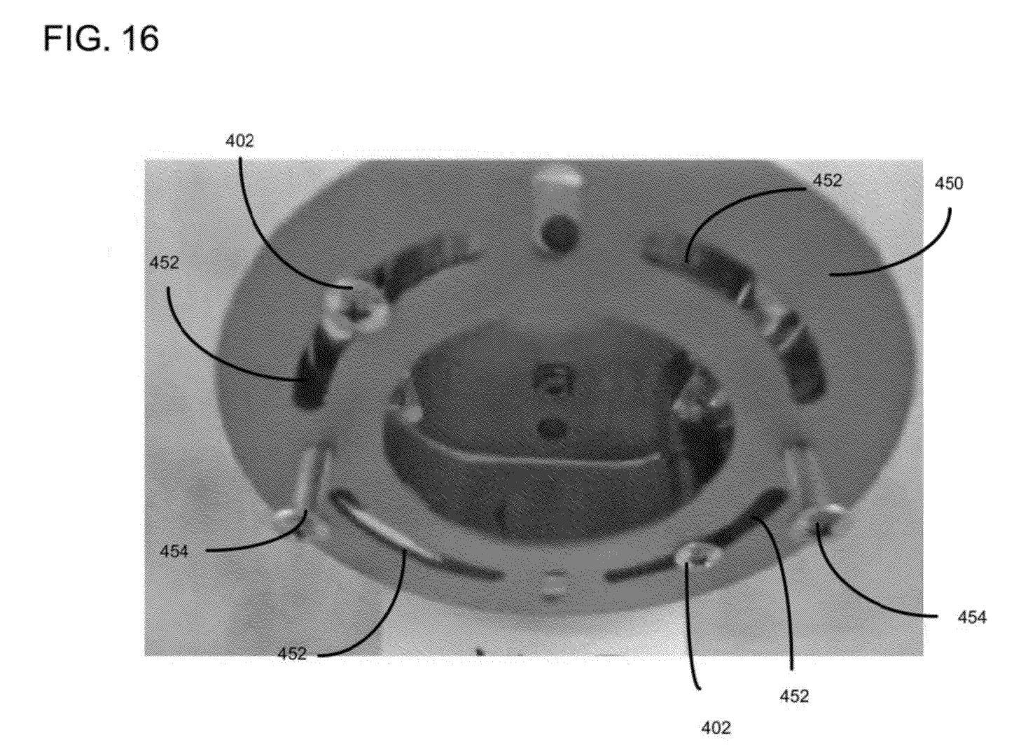

FIG. 16 is a bottom view illustrating an adapter plate 450 mounted to the standard box 400 in another embodiment of the present invention. The adapter plate may include one or more curved slots 452. The curved slots preferably have a curvature equivalent to the curvature of the perimeter of the adapter plate. The mounting screws 402 are positioned within these slots. The slots enable the adapter plate to be rotated as desired to a desired orientation. Thus, the adapter plate is rotated to the desired orientation and the mounting screws 402 are tightened to hold the fan bracket assembly securely against the adapter plate and the box 400. The fan bracket assembly is attached to the adapter plates with bracket screws 454 inserted into receiving holes 456.

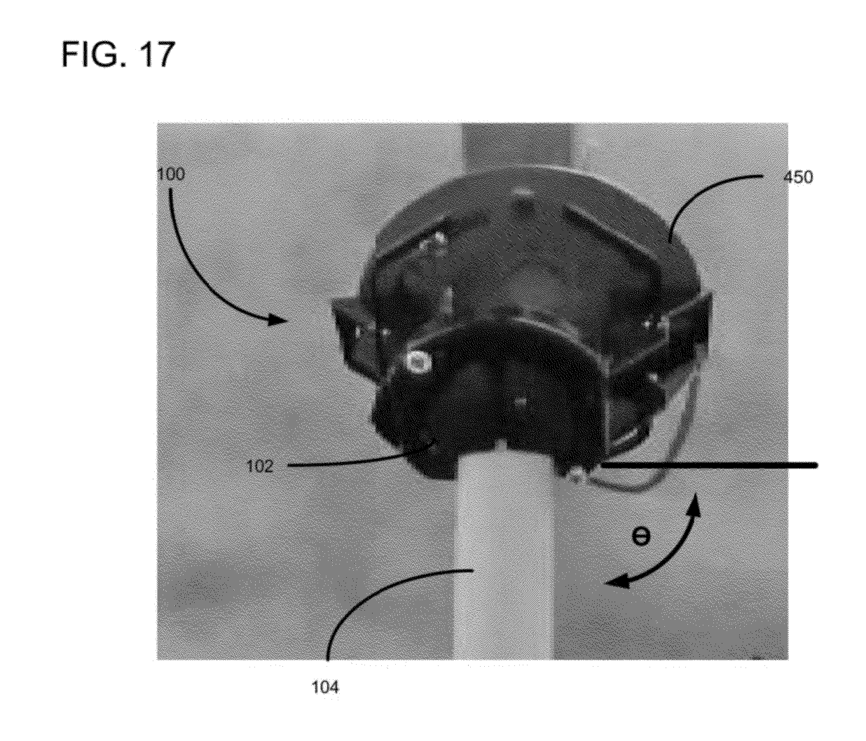

FIG. 17 is a side view illustrating the mounting ball 102 and down rod 104 positioned in the fan bracket assembly 100 attached to the adapter plate 450 and standard box 400. The adapter plate is rotated as necessary to move the position of the bracket screws and associated receiving holes 456 at such a position that the fan bracket assembly is aligned to allow the down rod to extend straight down.

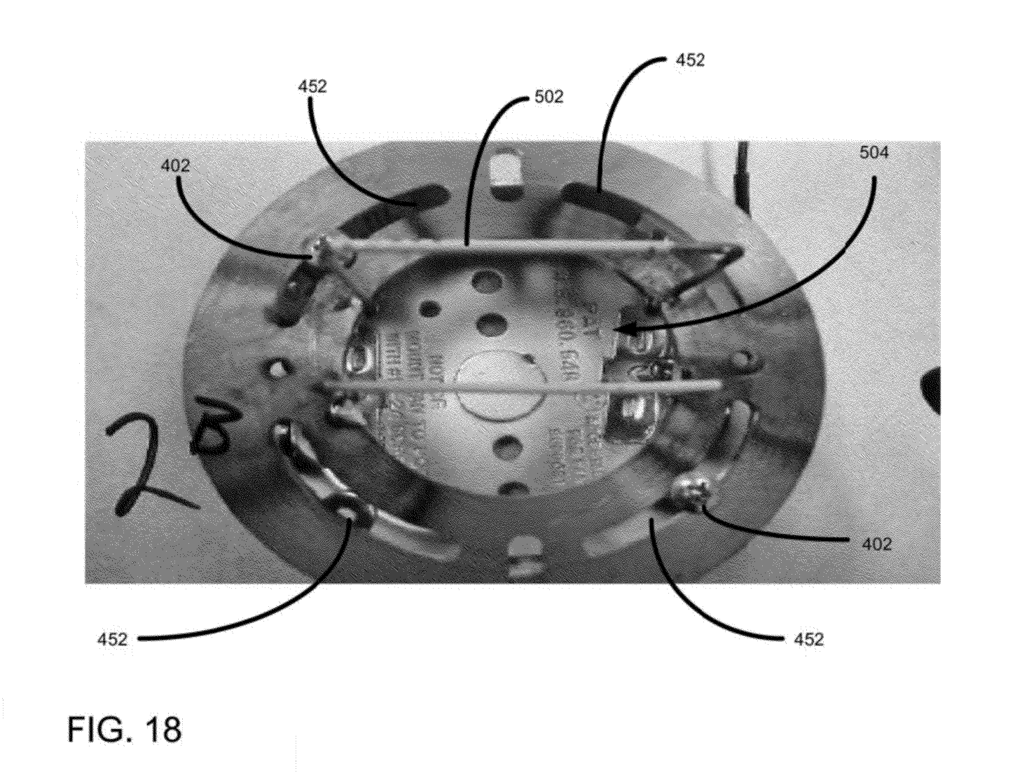

FIG. 18 is a bottom view illustrating an adapter plate 500 in an alternate embodiment of the adapter plate 450 of FIG. 16. The adapter plate 500 includes retaining bars 502 and an open area 504 sized and shaped to retain a remote control mechanism 200. The adapter plate 500 is substantially the same as the adapter plate 450, however the adapter plate 500 includes the retaining bars to retain a remote control mechanism. In this embodiment, the fan bracket assembly may include retaining bars and an open area for a remote control mechanism.

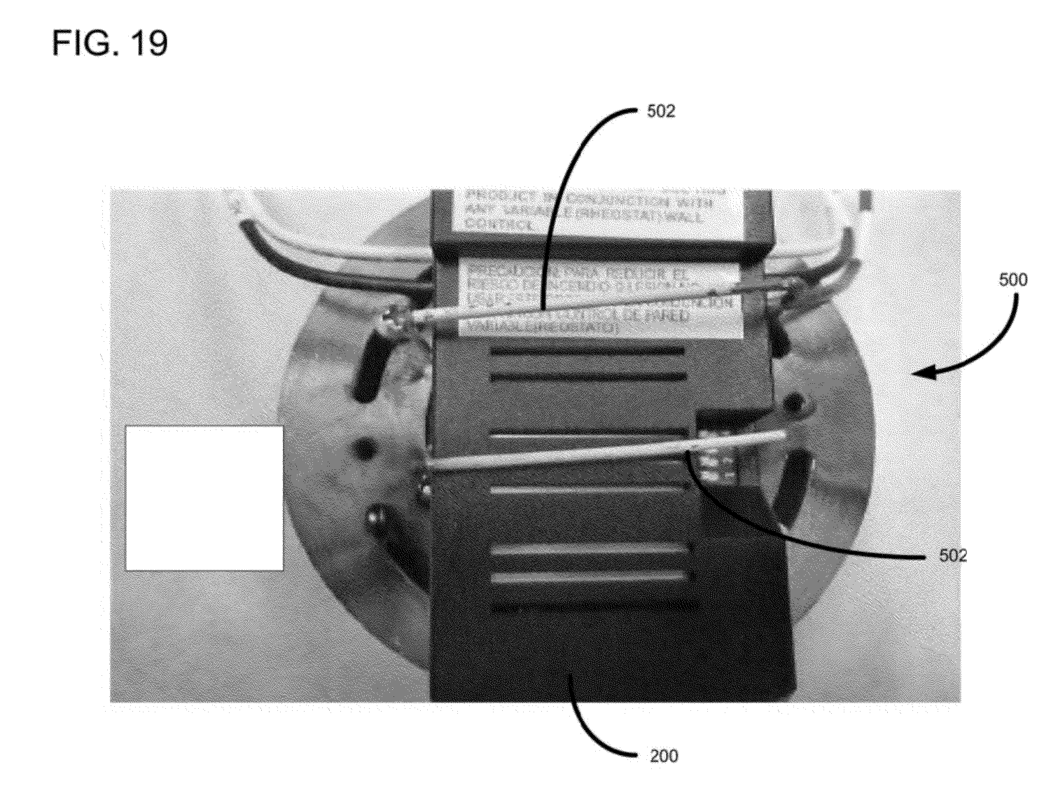

FIG. 19 is a bottom view illustrating the adapter plate 500 of FIG. 18 holding a remote control mechanism 200. The remote control mechanism may be retained by the retaining bars 502 in the open area 504.

In an alternate embodiment of the present invention, the adapter plate 500 may be an integral component of the fan bracket assembly where the fan bracket assembly and adapter plate 500 is one piece. Thus, the entire fan bracket assembly may be rotated to a desired axial orientation, thereby allowing the down rod to hang straight down.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A fan bracket assembly for supporting a fan assembly from a slanted surface, the fan bracket assembly comprising:
a main body having a peripheral section and an open area, the main body having an extension;
a mechanism for affixing the main body to a slanted surface;
a detachable mounting ball sized and shaped to fit and be retained within the peripheral section, the mounting ball having a surface area extending beyond a horizontal reference line bisecting the mounting ball;
wherein the mounting ball includes a slot on the surface area extending beyond the horizontal reference line;
wherein the extension is positioned within the slot to rotationally restrain the mounting ball;
a down rod attached to the mounting ball for supporting a fan assembly;
wherein the open area of the main body is sized to hold wiring of the fan assembly;
wherein the main body is affixed to the slanted surface and the extension remains within the slot.

2. The fan bracket assembly according to claim 1 wherein the open area is sized to hold a remote control mechanism for a fan assembly.

3. The fan bracket assembly according to claim 2 wherein the main body includes a plurality of retainer arms for retaining the remote control mechanism in the open area.

4. The fan bracket assembly according to claim 1 wherein the affixing mechanism includes a plurality of wing segments affixed to the main body, wherein screws are fastened through the wing segments for affixing the main body to the slanted surface.

5. The fan bracket assembly according to claim 1 wherein the down rod includes a collar, the collar including means for affixing the down rod having a first diameter to a mounting ball sized to fit a second diameter larger than the first diameter.

6. The fan bracket assembly according to claim 5 wherein the collar is affixed to the down rod.

7. The fan bracket assembly according to claim 1 wherein the mounting ball includes a slanted top.

8. The fan bracket assembly according to claim 1 wherein the mounting ball is spherical.

9. The fan bracket assembly according to claim 1 further comprising an adapter plate for moving the axial orientation of the fan bracket assembly in relationship to a box to which the fan bracket assembly is affixed.

10. The fan bracket assembly according to claim 9 wherein the adapter plate includes a plurality of retainer arms for retaining a remote control mechanism.

11. The fan bracket assembly according to claim 9 wherein the adapter plate includes a plurality of curved slots positioned on a planar surface of the adapter plate.

12. The fan bracket assembly according to claim 11 wherein the adapter plate includes a plurality of curved slots, each slot having a curvature substantially equivalent to a curvature of the perimeter.

13. The fan bracket assembly according to claim 11 wherein a plurality of screws is positioned within the curved slots for affixing the adapter plate to the box.

14. An adapter plate for attachment for moving an axial orientation of a fan bracket assembly affixed to a surface, the adapter plate comprising:
a planar surface with a plurality of slots;
a retention mechanism for retaining the fan bracket assembly to the adapter plate; and
a retention mechanism for retaining the adapter plate to a surface;
wherein the planar surface may be rotated to change the axial orientation of the fan bracket assembly in relationship to surface to which the fan bracket assembly is affixed.

15. The adapter plate according to claim 14 wherein the adapter plate includes a plurality of retainer arms for retaining a remote control mechanism.

16. The adapter plate according to claim 14 wherein the plurality of slots are curved.

17. The adapter plate according to claim 16 wherein the curved slots having a curvature substantially equivalent to a curvature of the perimeter.

18. The fan bracket assembly according to claim 14 wherein the retention mechanism for retaining the adapter plate to a surface includes a plurality of screws positioned within the curved slots for affixing the adapter plate to the surface.

19. The fan bracket assembly according to claim 14 wherein the surface is a slanted surface.

20. A fan bracket assembly for supporting a fan assembly from a surface, the fan bracket assembly comprising:
a main body having a peripheral section and an open area, the main body having an extension;
an affixing mechanism for affixing the main body to a surface;
a detachable mounting ball sized and shaped to fit and be retained within the peripheral section, the mounting ball having a slot and a slanted top end;
wherein the extension is positioned within the slot to rotationally restrain the mounting ball;
a down rod attached to the mounting ball for supporting a fan assembly;
wherein the open area of the main body is sized to hold wiring of the fan assembly and a remote control mechanism for a fan assembly;
wherein the main body is affixed to the surface.
